(19) United States
(12) Patent Application Publication
(10) Pub. No.: US 2026/0257570 A1
(43) Pub. Date: Sep. 3, 2026

(54) MODULE FOR ABOVE-GROUND INSTALLATION OF ELECTRICAL CABLES

(71) Applicant: TOKHEIM SERVICES FRANCE, Le Plesis-Robinson (FR)

(72) Inventors: Francois PARNIERE, Le Plesis-Robinson (FR); Jean-Paul BESSON, Le Plesis-Robinson (FR)

(21) Appl. No.: 18/867,204

(22) PCT Filed: May 17, 2023
(86) PCT No.: PCT/FR2023/050715

§ 371 Date: Nov. 19, 2024

(30) Foreign Application Priority Data
May 20, 2022 (FR) FR2204862

(51) Int. Cl. B60L 53/30; H02G 9/04

(52) U.S. Cl. CPC B60L 53/30; H02G 9/04

(57) ABSTRACT

TITLE: Module for above-ground installation of electrical cables Module (1) for an above-ground electrical cable installation for an electric vehicle charging station infrastructure. The module (1) comprises a longitudinally-profiled rectangular block with a trapezoidal cross-section including: a slab (1) forming the bottom of a longitudinal channel accommodating the cables and edged by a reinforced front edge (12), a back edge (13) forming a wall with at least one cut-out (131), a rebate (123, 133) formed by the top of the front edge (12) and the back (13), and a grating (2) at the top, inserted in the rebate (123, 133).

### FIELD OF THE INVENTION

This invention refers to a module for an above-ground electrical cable installation for an electric vehicle charging station infrastructure and to a tool for picking up and handling such modules for their placing in an electric vehicle charging station infrastructure.

### STATE OF THE ART

There are many distinct types of charging station infrastructures for electric vehicles. Generally speaking, such infrastructures are powered by electrical cables embedded in the walls or buried underground, supplying the vehicle connection points.

Installations with cable trays formed by perforated cableways or ladders tend to be relatively expensive and are difficult and time-consuming to install, requiring a support such as a wall or posts.

In short, the installation of such infrastructures is relatively complicated and costly, limiting their development.

### PURPOSE OF THE INVENTION

The purpose of this invention is to develop a module for the simple installation of electrical cables above ground in an electric vehicle charging station infrastructure.

### ABSTRACT AND ADVANTAGES OF THE INVENTION

For this purpose, the invention concerns a module for an above-ground installation of electric cables for an electric vehicle charging station infrastructure, this module being characterised in that it comprises a longitudinally profiled rectangular block having a trapezoidal cross-section including: a slab forming the bottom of a longitudinal channel accommodating the cables and edged by: a reinforced front edge and a back edge forming a wall with at least one cut-out, a rebate formed by the top of the front edge and of the back, and a grating at the top, inserted in the rebate. The module described in this invention allows electrical cables to be installed quickly and easily for an electric vehicle charging station infrastructure. This above-ground installation is protected without it being necessary to bury the electrical cables at least partly, or to cut grooves or drill holes in the infrastructure walls.

This installation also offers an advantage wherein its layout can be adapted to suit requirements and the space available or its development.

Advantageously, the module is made of rubber, in particular from recycled tyres. This module thus ensures tyre recycling and is itself recyclable.

An advantageous feature of the slab is that it has a discontinuous longitudinal partition establishing two cavities forming a support level with the rebates to accommodate the grating covering the module and the cable channel.

Separating the module into two cavities is a way of dividing the cables to form two groups, for example, to prevent or deter the reciprocal heating between the cables.

This also makes for limited cable cross-sections and cost. This reduction in the heating interaction is also furthered by the very nature of the material of which the block is made, i.e. rubber.

Another feature is that the bottom of the slab comprises transverse channels forming water passages opening out at the front and rear of the module.

For outdoor installation, the module or, more generally, the row formed by a combination of modules, does not form a barrier with respect to rainwater flowing in on either side of the modules.

Another advantageous feature is that the back and the partition comprise cut-outs and discontinuities that are staggered with respect to each other so that cables can be routed through them or water can drain from the module compartments without weakening the transverse line and also supporting the grating.

An advantageous feature is that the front edge of the module is reinforced by its trapezoidal cross-section with a ramp-like front face fitted with signalling devices.

The front edge of the module and the row comprising the assembly of modules act as a wheel stop for slow-manoeuvring vehicles at the charging station in front of the module or row of modules.

The signage devices draw the drivers' attention to this front edge, which demarcates the boundary of the parking spaces for vehicle charging.

### BRIEF DESCRIPTION OF THE ILLUSTRATIONS

This invention is described in greater detail below based on an example of a module shown in the attached illustrations in which:

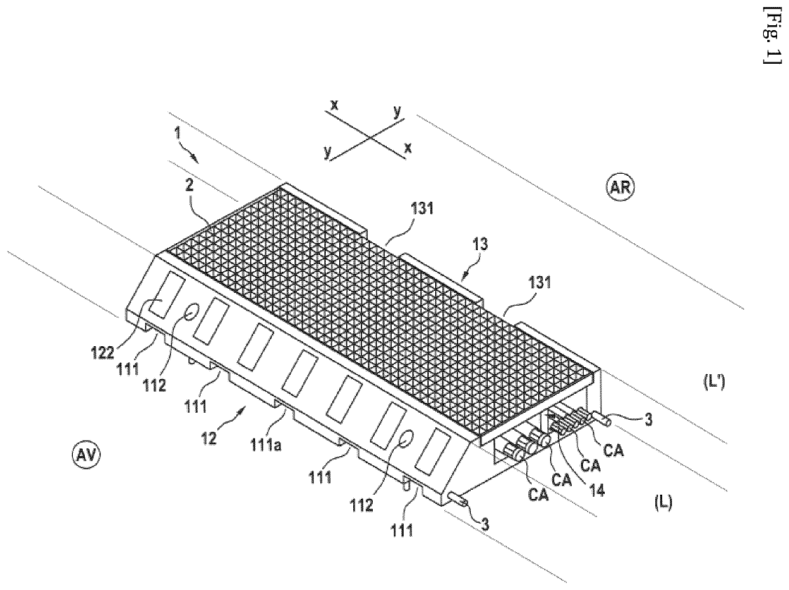

FIG. 1 is a perspective view of a module outlining the module assembly line,

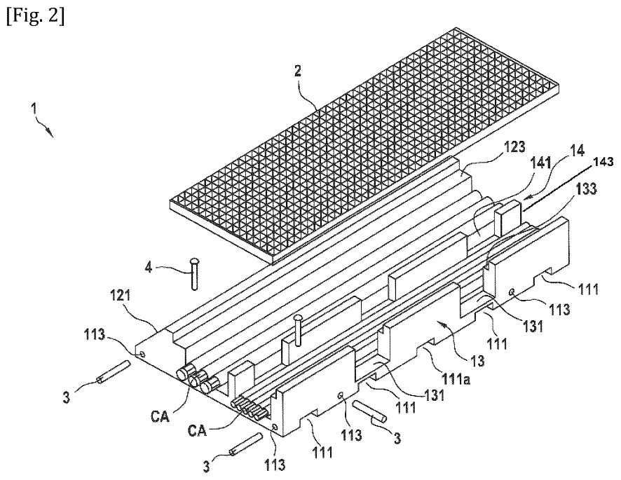

FIG. 2 is an exploded view of the module,

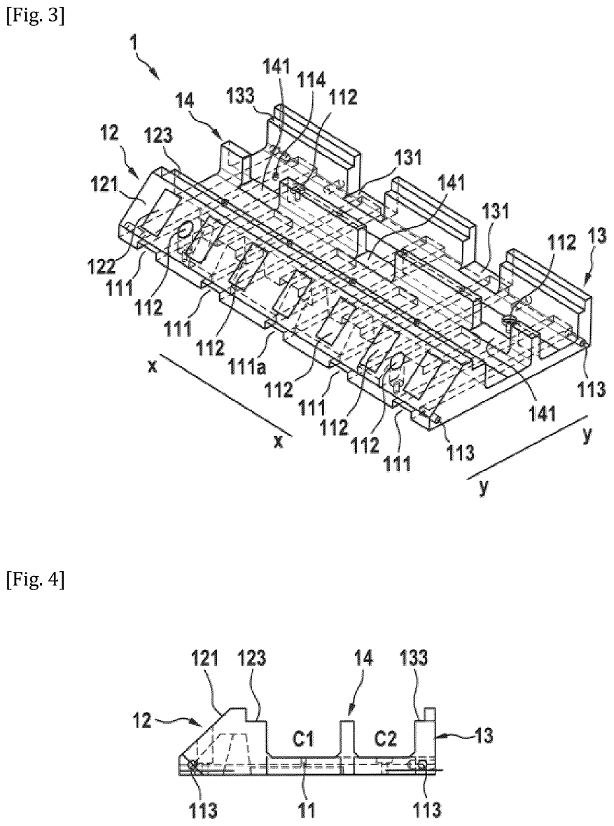

FIG. 3 is a perspective view of the module without the grating,

FIG. 4 is a side view of the module,

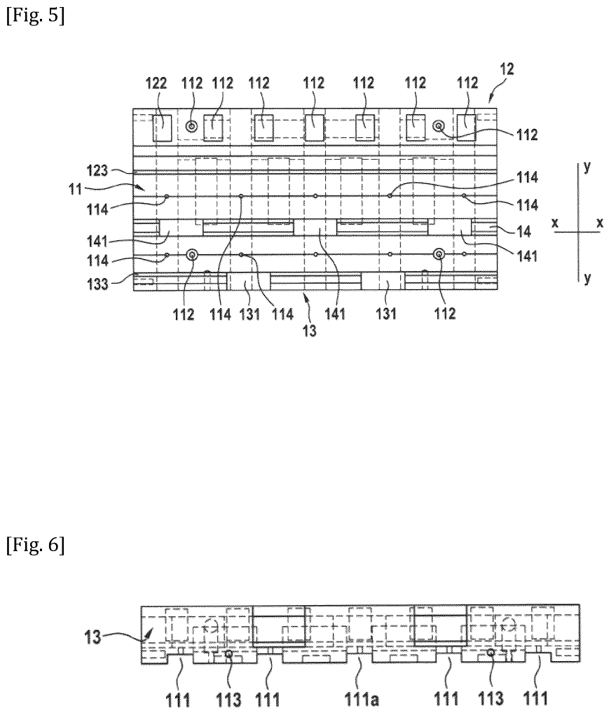

FIG. 5 is a top view of the module,

FIG. 6 is a rear view of the module,

### DESCRIPTION OF AN EMBODIMENT OF THE INVENTION

According to FIG. 1, the purpose of the invention is a module 1 for the implementation of an above-ground electrical cable installation for an electric vehicle charging station infrastructure.

This installation is sketched in lines depicting an alignment (L) of modules 1, assembled by the shorter sides. This alignment may be doubled by a symmetrical alignment (L′) of modules placed back-to-back respect to the modules 1 in alignment (L).

Module 1 is prismatic, rectangular, and trapezoidal in cross-section. The alignment (L) corresponds to the longitudinal direction XX. The front (AV) and rear (AR) sides in the transverse direction YY are shown in FIG. 1. The module 1 is placed on the ground where it is attached by bonding or by mechanical fastening such as by anchoring with screws and plugs.

The modules form one or more longitudinal channels accommodating power supply cables for the connection terminals mounted to posts secured in the pavement near the rear side of the modules and between the two alignments (L), (L′) of modules 1. Cable ends are shown in FIG. 1. The inclined front face 121 of module 1 has reflective plates 122 making the installation more visible.

The inclined face 121 forms a ramp designed to mark out the location for the vehicle and act as a wheel stop.

### The Top of Module 1 Is Covered by a Grating 2.

In more detail, according to the exploded view (FIG. 2), the module 1 comprises a slab 111 forming the bottom of the module contained between a front edge 12 with an inclined surface 121 and a rear wall forming the back 13. The top of the front edge 12 has a rebate 123 and the back 13 has a rebate 133 at the same height as the front edge to accommodate the grating 2.

The inclined face 121 acts as a wheel stop to hold back a slowly manoeuvring vehicle with respect to module 1 or a line (L) of modules. The inclined face 121 incorporates signalling devices 122 comprising auto-reflecting luminous plates to clearly identify the front edge 12 of the module or row of modules.

The longitudinal channel formed by the slab 1, the front edge 12 and the back 13 is subdivided into two compartments C1, C2 by a longitudinal partition 14, the top 143 of which is at the same height as the bottom of the rebates 123, 133 to support the grating 2 and also to form compartments C1, C2 separating the power cables, which can heat considerably during the vehicle battery charging.

These compartments C1, C2 can also be used to separate power cables from signal transmission cables.

The back 13 has cut-outs 131 for the lateral out-feed of connection cables and for draining rainwater entering the channel through the grating 2.

The partition 14 is also discontinuous, with cut-outs 141 for rainwater to flow through. These cut-outs 141 do not face transversely the cut-outs 131 in the back 13 so as to more evenly distribute the weight applied to the grating by a pedestrian. The modules 1 of a line (L), (L′) are assembled by means of assembly pins 3 fitted into assembly holes 113 made in the slab 11 on the sides and the back 13.

The slab 11 has transverse channels 111 open at the bottom and at the sides to allow rainwater running over the ground surface to pass through the lines of modules (L), (L′).

The top of slab 11 is preferably slightly inclined and perforated in line with the channels for draining rainwater.

The modules 1 can be fastened to the pavement by screwing them into fastening holes 112 with screws 4 at the front edge 12 passing through the slab 1 near the back 13.

FIGS. 3-6 also show the shape of module 1 without the grating 2, from a different angle and in side, top and front views.

FIG. 3 is a detailed view of module 1 without the grating and without the electrical cables, underlining the shape of the longitudinal compartments C1, C2 forming cable trays and the locations of the holes 112 for fastening to the pavement and the holes 114 for draining water, passing through the slab 11 at the transverse channels 111 in each compartment C1, C2.

FIG. 4 shows the trapezoidal cross-sectional shape of module 1 without the grating 2.

FIG. 5 is a top view of the module 1 without the grating 2, showing the distribution of the cut-outs 131 in the back 13, the offset cut-outs 141 in the partition 14 and the holes 112 for fastening to the pavement.

FIG. 5 is a view of the back 13 illustrating in particular the cross-section of the transverse channels 111 and the assembly holes 113 of the back 13 in the slab 11.

Module 1 as shown above is preferably made from tyre rubber recovered by moulding and integrating the signalling devices 122.

Preferably, an SBR granulate, a styrene-butadiene rubber, is used. This material has excellent mechanical properties in terms of resistance to abrasion and bending.

For instance, module 1 is preferably 100 cm long, 50 cm wide and weighs around 22 kg. It has cavities designed to reduce the mass of material and limit the weight so that a single person can handle it. The cut-outs 131, 141 in the back 13 and the partition 14 and the through-holes 111 also contribute to this reduction in the mass of material and weight, whilst not affecting the strength of the module 1, which has a structure comprising crossed parts: the front edge 12, the back 13 and the partition 14 in the longitudinal direction XX and the cross-pieces formed by the slab 11 between the through-holes 111 in the transverse direction.

### LIST OF MAIN COMPONENTS

1 Module
11 Slab
111 Transverse channel
111a Median transverse channel
112 Pavement fastening hole
113 Module assembly hole
114 Through-hole
115 Assembly pin
12 Front edge
121 Sloping surface forming a ramp
122 Signalling device
123 Rebate
13 Back
131 Cut-out
133 Rebate
14 Partition
141 Cut-out
143 Top of partition
3 Assembly pin
4 Screws
XX Longitudinal direction
YY Transverse direction
C1: Compartments
CA Cables

1. A module (1) for an above-ground electrical cable installation for an electric vehicle charging station infrastructure, characterized in that
the module is formed by a longitudinally profiled rectangular block with a trapezoidal cross-section comprising:
(a) a slab (1) forming the bottom of a longitudinal cable channel and bordered by:
(i) a reinforced front edge (12) forming a wheel stop,
(ii) a back (13) forming a wall with at least one cut-out (131),
(iii) a bottom with transverse channels (111) forming water passages opening out at the front (AV) and rear (AR) of the module (1),
(b) a rebate (123, 133) formed by the top of the front edge (12) and the back (13), and
(c) a grating (2) accommodated by the rebate (123, 133) at the top.

2. The module (1) according to claim 1, characterized in that
the module is made from rubber, specifically recycled tires.

3. The module (1) according to claim 1, characterized in that
the slab (1) comprises a discontinuous longitudinal partition (14) delimiting two cavities (C1, C2), the top (143) of which forms a support at the level of the rabbets (123, 133) for the grating (2).

4. The module according to claim 3, characterized in that
the cut-outs (131) in the back (13) and the discontinuities in the form of cut-outs (141) in the partition (14) are offset longitudinally (XX direction) so that they do not face each other transversely.

5. The module (1) according to claim 1, characterized in that
the reinforced front edge (12) has a trapezoidal cross-section with a ramp-like front face fitted with signaling devices (122).

6. The module (1) according to claim 1, characterized in that the module comprises
assembly holes (113) in the transverse faces and the back (13), in the thickness of the slab (1) receiving assembly pins (3) for joining adjacent modules, longitudinally and/or back to back.

7. The module (1) according to claim 2, characterized in that the module comprises assembly holes (113) in the transverse faces and the back (13), in the thickness of the slab (1) receiving assembly pins (3) for joining adjacent modules, longitudinally and/or back to back.

8. The module (1) according to claim 3, characterized in that the module comprises
assembly holes (113) in the transverse faces and the back (13), in the thickness of the slab (1) receiving assembly pins (3) for joining adjacent modules, longitudinally and/or back to back.
